(19) United States
(12) Patent Application Publication
(10) Pub. No.: US 2008/0205801 A1
(43) Pub. Date: Aug. 28, 2008

(54) Method of Producing a Gusseted Bag from a Plastic Film and Bag Thus Obtained

(75) Inventor: Patrick Alaux, Unieux (FR)

Correspondence Address: CANTOR COLBURN, LLP, 20 Church Street, 22nd Floor, Hartford, CT, 06103, US

(73) Assignee: AUTOBAR FLEXIBLE PACKAGING, MONTFAUCON EN VELAY (FR)

(21) Appl. No.: 11/817,740

(22) PCT Filed: Feb. 13, 2006
(86) PCT No.: PCT/FR06/50129

§ 371 Date: Dec. 6, 2007

(30) Foreign Application Priority Data
Mar. 2, 2005 (FR) 0550547

(51) Int. Cl. B65D 30/20; B31B 39/00

(52) U.S. Cl. 383/120; 493/267

(57) ABSTRACT

The invention relates to a bag comprising side gussets (1a) which extend along only part of the height thereof, such as to form walls (1b1), (1c1) at a certain distance (a) from the opening of the bag, which can be assembled directly to one another along the side edges thereof. The upper end of the gussets is closed by means of an external fold area which is folded at 45° such as to define an essentially-triangular shape (1a4) that is disposed between the two folds of the gussets.

### TECHNICAL FIELD OF HE INVENTION

The invention relates to the technical field of plastic packaging bags, for example bags of the type designed to contain animal feedstuffs.

### BRIEF DISCUSSION OF RELATED ART

Advantageously and as well known to those skilled in the art, these types of bags may have, on their lateral edges, gussets capable of increasing the capacity of the bag and improving its stability.

Generally speaking, the gussets are made over the entire height of the bag.

Various manufacturing methods can be envisaged. For example, bags are commonly made from a single plastic film by using a continuous process. The film is subjected to successive folding operations in order to produce lateral gussets between two walls. The external folds of the gussets thus produced are generally assembled by welding operations. The bottom of the bag is also produced by continuous welding and is then turned over and attached to one of the walls of the bag.

Such arrangements are not described in detail here because they are perfectly familiar to those skilled in the art.

In this embodiment, the gussets are therefore made over the entire height of the bag by successive folding. It is therefore apparent that, at the opening of the bag, the ends of said opening are delineated by four walls as a result of the cross section of the gussets.

These arrangements make it necessary to use specific means in order to ensure leaktight closure of the bag. There may also be certain difficulties in fitting the upper part of the bag, where it opens, with means of temporary opening and closing of the ZIP®, ECLAIR®, etc. type.

In order to overcome these drawbacks, there have been proposals to produce plastic bags having lateral gussets which extend over only part of the height of the bag to within a certain distance of the opening of said bag. As a result, above the gussets, the lateral ends of the opening consist of only two wall thicknesses.

This type of bag is disclosed. for example, by Document EP 1.250.999 which describes a method of producing gusseted bags. Nevertheless, the method described in that document relates to a concept for producing bags which is totally different.

In fact, the bag is not formed from a single plastic film subjected to successive folding operations in order to produce gussets but is made of two independent films, the walls of which are joined by independent, separately mounted gussets. It is obvious that, using this solution, it is possible to envisage producing bags with gussets having a height which is less than the total height of the desired bag, given the fact that such gussets are produced independently.

It is, however, apparent that the separate mounting of the gussets reduces production rates significantly.

Patent JP 07100972 relates to a method of producing bags which uses specific means in order to form the gusset over only part of the height of the bag. This technical solution is expensive and does not make it possible to achieve high production rates.

### BRIEF SUMMARY OF THE INVENTION

The invention overcomes the above drawbacks simply, reliably, effectively and efficiently.

The problem which the invention aims to solve is to produce a gusseted bag from a plastic film, the gussets being made by successive folding of said film, i.e. they are not separately mounted, and having a height which is less than the total height of the desired bag. This technical solution made it necessary, in particular, to solve the important problem of ensuring leaktight closure of the upper end of the gussets below the free part of the walls resulting from the absence of a gusset.

In order to solve this problem, a production method has been devised whereby:
the film is subjected to successive folding operations in order to produce lateral gussets between two walls;
the bottom of the bag is made;
the external folds of the gussets are assembled, over part of the height, to within a certain distance of the opening of the bag;
the gussets are detached as far as their assembly area so as to form a free gusset part and a free wall part;
at least one of the free wall parts is turned down in order to release the free gusset part;
each free gusset part is subjected to a twisting and 45° and folding movement protruding beyond the lateral edges of the walls corresponding to the closure of each gusset;
the free protruding gusset part resulting from said twisting and folding movement is cut;
the free wall part is turned up over the 45° closed end of the gusset;
the free edges of the walls of the bag are assembled over the above-mentioned distance.

According to another aspect, the free wall edges are assembled above the 450 closed end of the gussets. The various assembly operations are performed by welding.

Advantageously, the upper part of the bag near its opening is fitted with a closure system.

Given the basic characteristics of the method according to the invention, the bag obtained has lateral gussets over only part of its height so as to leave, over a certain distance from the opening of the bag, wall parts capable of being assembled directly to each other by their lateral edges, the upper end of the gusset being closed by an external area folded at approximately 45° delineating a substantially triangular external shape located between the two folds of the gussets. The external triangular shape may be attached to one of the folds of the corresponding gusset.

### BRIEF DESCRIPTION OF THE DRAWINGS

The invention is explained below in greater detail, reference being made to the accompanying drawings in which:

FIGS. 1a, 1b, 1c and 1d are purely schematic views showing the main phases of the method of producing a bag made of a plastic film;

FIG. 2 is a perspective view of the plastic bag in which the external folds of the gussets are welded over only part of the total height of the bag to within a given distance of the opening of the bag;

FIG. 3 is a front view of the bag after having detached the gussets as far as the area where they are assembled so as to form a free gusset part and a free wall part, one of which is shown turned down;

FIGS. 4, 5 and 6 are front views showing, based on FIG. 3, the various phases of the method of producing the bag.

FIG. 7 is a perspective view of the bag resulting from the method in FIGS. 3, 4, 5 and 6;

FIG. 8 shows the open bag after filling;

### DETAILED DESCRIPTION OF THE INVENTION

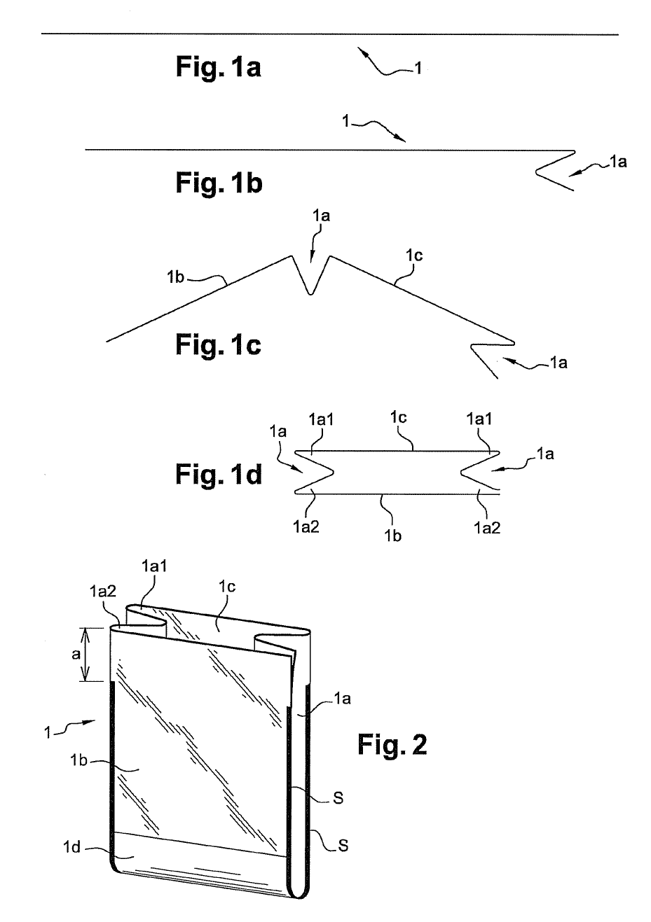

As indicated and as perfectly familiar to those skilled in the art, the gusseted bag according to the invention is made of a plastic film (1) which is subjected to successive folding operations in order to produce lateral gussets (1a) between two walls (1b) and (1c). (FIGS. 1a, 1b, 1c and 1d).

These arrangements are perfectly familiar to those skilled in the art and are not described in detail. The same applies to producing the bottom (1d) which can be obtained by assembling the lower edge of the two walls (1a) and (1b) by welding and folding over onto one of walls (1a) or (1b).

According to the invention, external folds (1a1), (1a2) of gussets (1a) are assembled over only part of the desired height of the bag, for example to within a certain distance (a) of opening (1e). Classically, the folds (1a1) and (1a2) of each gusset (1a) can be assembled by a welding operation for example (FIG. 2).

In another stage of the method according to the invention, the gussets (1a) are detached as far as the area where they are assembled so as to form a free gusset part (1a3) and a free wall part (1b1), (1c1). For example, this detachment of the gussets (1a) as far as the corresponding weld line (S) may be the result of simply cutting each of folds (1a1), (1a2) of each gusset.

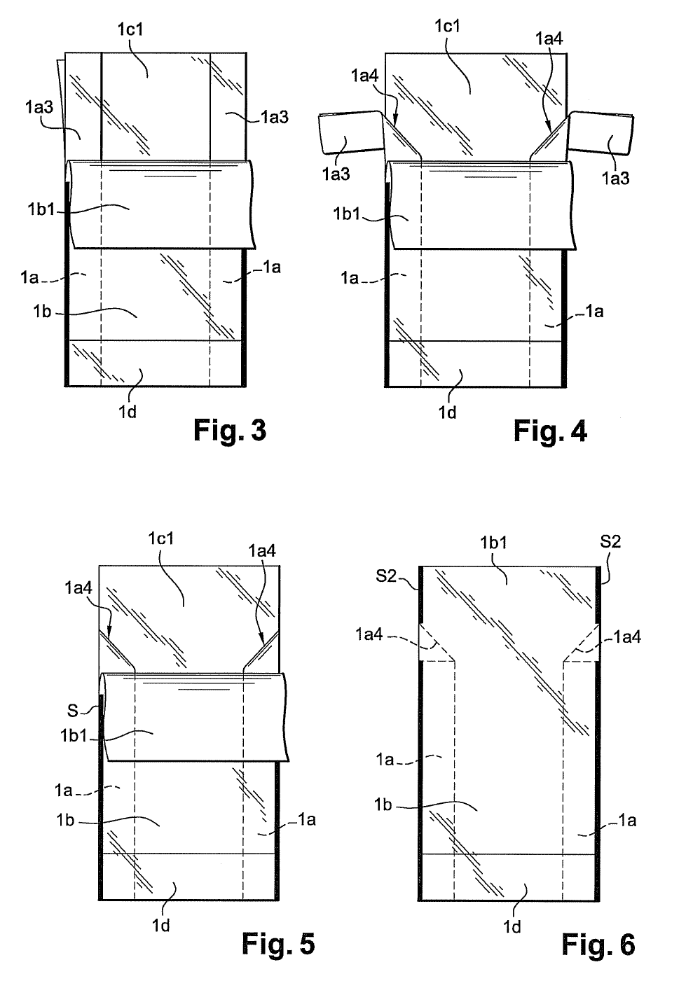

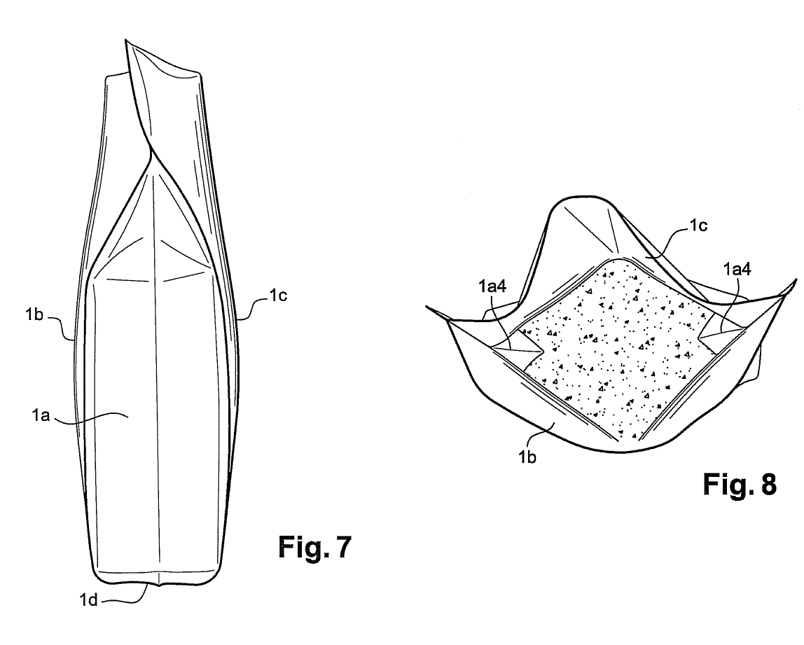

Each free gusset part (1a3) is then subjected to an operation capable of ensuring upper transverse closure of the gussets starting from the end of the assembly line (S) of the external folds (1a1), (1a2) of each gusset (1a). These operations to transversely close the upper ends of the gussets are performed after having turned down at least one of the free wall parts (1b1) in order to release the free gusset part (1a3) (FIG. 3).

On the basis of this design, various technical solutions can be envisaged.

In the embodiment shown in FIGS. 4, 5 and 6, each free gusset part (1a3) is subjected to a twisting and 45° folding movement protruding beyond the lateral edges of the walls (FIG. 4). This twisting and 45° folding movement (1a4) ensures closure of each gusset.

The protruding part resulting from said twisting and folding movement (FIG. 5) is then cut. The free wall part (1b1) is folded up over the end of the gussets closed at 45°. It is then possible to assemble the lateral edges of the two free walls (1b1), (1c1) by weld line (S2), for example above the upper closed ends (1a4) of the gussets (FIG. 6).

Given the various stages in the method, the bag obtained has lateral gussets (1a) over only part of the total height of the bag so as to leave, at a certain distance (a) from the opening of the bag, a free wall part (1b1) and (1c1).

These two free wall parts (1b1) and (1c1) can be assembled by their lateral end by welding (S2) for example over two thicknesses only. The upper end of each gusset (2a) is closed by the internal 450 folded area (1a4) delineating a substantially triangular shape.

This triangular shape is located between the two folds (1a1), (1a2) of the corresponding gusset (1a). Note that this triangular shape can be attached (by welding for example) to one of the folds of the corresponding gusset.

FIG. 8 shows the bag opened and filled with a product. In this Figure, one can see the end of the gussets closed by folding at roughly 45°.

After filling, in particular, the bag is closed and made leaktight by the upper horizontal edge of the free wall parts (1b1), (1c1). Also note that one of the walls (1b1) for example, may be fitted with a temporary opening and closing system of the ZIP®, ECLAIR®, etc. type.

The advantages of the invention are apparent from the description, the possibility of making the gussets from a film of plastic over a height which is less than the total height of the bag so that there are only two wall thicknesses in the area where the bag is closed being emphasised and pointed out in particular.

1. A method of producing a gusseted bag from a plastic film (1):
film (1) is subjected to successive folding operations in order to make lateral gussets (1a) between two walls (1b) and (1c);
the bottom (1d) of the bag is produced;
external folds (1a1), (1a2) of gussets (1a) are assembled over part of the height to within a certain distance (a) of the opening of the bag;
the gussets (1a) are detached as far as the area where they are assembled so as to form a free gusset part (1a3) and a free wall part (1b1), (1c1);
at least one of the free wall parts (1b1) is turned down in order to release the free gusset part (1a3);
each free gusset part (1a3) is subjected to a twisting and 45° folding movement protruding beyond the lateral edge of the walls corresponding to closure of each gusset;
the free and protruding gusset part resulting from said twisting and folding movement is cut;
free wall part (1b1) is turned up over the end of the gussets closed at 45°;
the free edges (1b1), (1c1) of the walls of the bag are assembled over the above-mentioned distance.

2. A method as claimed in claim 1, characterised in that the free wall edges (1b1), (1c1) are assembled above the end of the gussets closed at 45°.

3. A method as claimed in claim 1, characterised in that the various assembly operations are performed by welding.

4. A method as claimed in claim 1, characterised in that the upper part of the bag, near its opening, is fitted with a closing system.

5. A bag obtained directly by using the method as claimed in claim 1 having lateral gussets (1a) over only part of its height so as to leave, at a certain distance (a) from the opening of the bag, wall parts (1b1), (1c1) capable of being assembled directly to each other by their lateral edges characterised in that the upper end of the gussets is closed by an external 45° folded area delineating a substantially triangular shape location between the two folds of the gussets.

6. A bag as claimed in claim 5, characterised in that the external triangular shape is attached to one of the folds of the gussets.
